(19) United States
(12) Patent Application Publication
(10) Pub. No.: US 2003/0050162 A1
(43) Pub. Date: Mar. 13, 2003

(54) Forming of containers

(76) Inventor: Alessandro Bianchini, Cognanto (IT)

Correspondence Address: WILLIAM COLLARD, COLLARD & ROE, P.C., 1077 NORTHERN BOULEVARD, ROSLYN, NY, 11576, US

(21) Appl. No.: 10/169,232

(22) PCT Filed: Jan. 2, 2001
(86) PCT No.: PCT/EP01/00068

(30) Foreign Application Priority Data
Dec. 31, 1999 (IT) M099A000288

(51) Int. Cl. B31B 1/64

(52) U.S. Cl. 493/129; 383/37

(57) ABSTRACT

A method for forming containers comprises selectively heating a first web (8) and second webs (10), joining together said first web (8) and said second web (10) along intended outlines (12) of containers (16) so as to form pouches (12a) bounded by said intended outlines and conduit means (44) leading out into said pouches, said conduit means (44) being suitable to inject therethrough a forming fluid, forming said containers (16, 50) by expanding said pockets by injecting said forming fluid through said conduit means (44); apparatus for forming containers, comprises indexing a first web (8) and a second web (10) of sheet material through a heating station (2) provided with selective heating means (24, 25) arranged to selectively heat said first web (8) more than said second web (10) and through a welding-and-forming station (4) in which opposing portions of said first web (8) and second web (10) are joined together by welding-and-forming means (26, 30) along intended outlines (12) of containers so as to form pouches (12a) and conduit means (44) leading out into said pouches (12a) to inject therein a forming fluid and form said containers (16) by expanding said pouches (12a).

WO-94/08852 discloses a forming system in which there are arranged in succession a preheating station for preheating of sheet material, a welding station, in which opposing regions of the sheet material are joined along intended outlines of containers so as to define pouches which are interconnected by conduits through which a forming fluid can be injected, a forming station, in which the forming fluid is injected into the pouches in order to expand the pouches up to form therefrom groups of containers, the formed containers being joined together by undeformed portions of the sheet material, a cutting station in which each group of containers is severed from the sheet material and advanced through a filling station, in which product is introduced into the formed containers through openings thereof, a sealing station in which the containers are sealed by closing said openings, and a cutting station in which the formed and sealed containers are cut out from the undeformed sheet material.

EP-0692364 discloses a similar forming system in which at least one further sealing and forming station is interposed between the welding station and the forming station, which allows more gradual forming of containers.

Peelable containers are known, comprising each a bulged wall joined together along its outline with a planar wall, the planar wall comprising a barrier sheet peelably detachable from a permeable sheet welded to said outline. Thus, when the barrier sheet is peelably removed from said permeable sheet, a content of the container can be emanated in the ambience atmosphere through the permeable sheet.

In the peelable containers according to the prior art, removal of the barrier sheet implies gripping one external portion thereof and tearing away the barrier sheet from the barrier sheet. However, gripping of the barrier sheet is difficult to achieve because the barrier sheet and the permeable sheet adhere to each other. An object of the invention is to improve forming of containers.

Another object of the invention is to improve opening peelability of containers. According to a first aspect of the invention, there is provided a method for forming containers, comprising heating sheet material, joining together first and second webs of said sheet material along intended outlines of containers so as to form pouches bounded by said intended outlines and conduit means leading out into said pouches, said conduit means being suitable to inject therethrough a forming fluid, forming said containers by expanding said pockets by injecting said forming fluid through said conduit means, characterized in that, said heating comprises selectively heating said first web more than the second web. According to a second aspect of the invention, there is provided apparatus for forming containers, comprising indexing a first web and a second web of sheet material through a heating station and through a welding-and-forming station in which opposing portions of said first web and second web are joined together by welding-and-forming means along intended outlines of containers so as to form pouches and conduit means leading out into said pouches to inject therein a forming fluid and form said containers by expanding said pouches, characterized in that said heating station comprises selective heating means arranged to selectively heat said first web more than said second web.

Owing to these aspects of the invention, it is possible to work webs of different materials, without incurring the risk that excessive heat damages any of the webs.

According to a third aspect of the invention, there is provided a method for forming containers, comprising heating sheet material, joining a first web and a second web of said sheet material along intended outlines of containers so as to form pouches bounded by said intended outlines and conduit means leading out into said pouches, said conduit means being suitable to inject therethrough a forming fluid, forming said containers by expanding said pouches by injecting said forming fluid through said conduit means, characterized in that, said expanding comprises expanding outer regions of said sheet material externally of said intended outlines so as to form in each container an opening region in which said first web and said second web are spaced apart from each other.

According to a third aspect of the present invention, there is provided apparatus for forming containers, comprising indexing a first web and a second web of sheet material through a heating station and through a welding-and-forming station in which opposing portions of said first web and second web are joined together by welding-and-forming means along intended outlines of containers so as to form pouches and conduit means leading out into said pouches to inject therein a forming fluid and form said containers by expanding said pouches, characterized in that said welding-and-forming means is provided with recess means for receiving regions of said sheet material externally of said intended outlines, in said regions said first web being distanced apart from said second web so as to define facilitating activating means of said container.

According to a fifth aspect of the invention, there is provided a container, comprising first wall means and second wall means defining an interior cavity in which a product is contained, a peripheral weld at which said first wall means and said second wall means are joined together, said second wall means comprising a peelable sheet peelably detachable from a permeable membrane welded to said first wall means at said peripheral weld, characterized in that, said first wall means and said second wall means are distanced apart from each other at an outer region externally of said peripheral weld to define a gripping zone of said second wall means.

In this way, containers having a facilitating peelability zone are formed in a particularly simple and economic way.

The invention can be better understood and carried out with reference to the drawings attached which show exemplifying and not restrictive versions thereof, wherein:

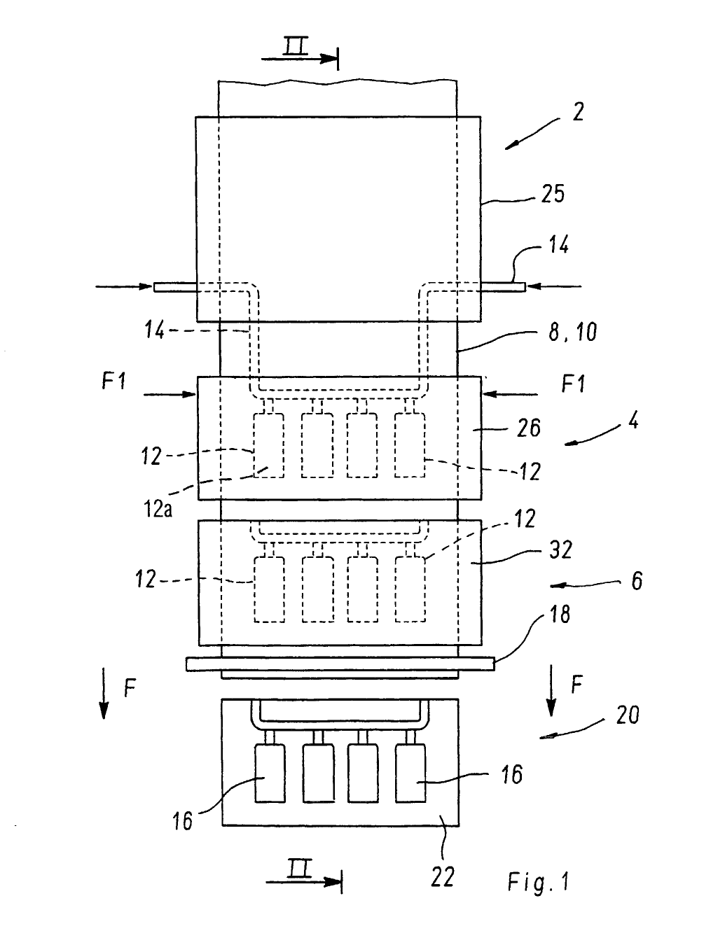

FIG. 1 is a front schematic view of a machine for forming containers from sheet material;

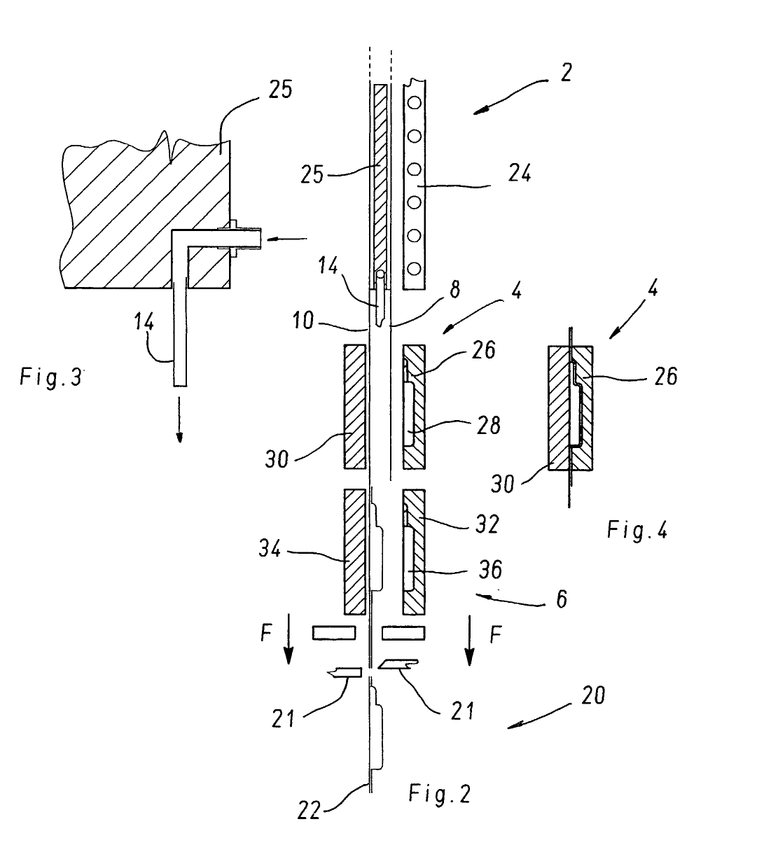

FIG. 2 is a section taken along the plane II-II of FIG. 1;

FIG. 3 is a highly enlarged and broken section of a version of the injection nozzles of the forming fluid;

FIG. 4 is a section as FIG. 2, but relative only to the sealing and forming station with mould in a closing position;

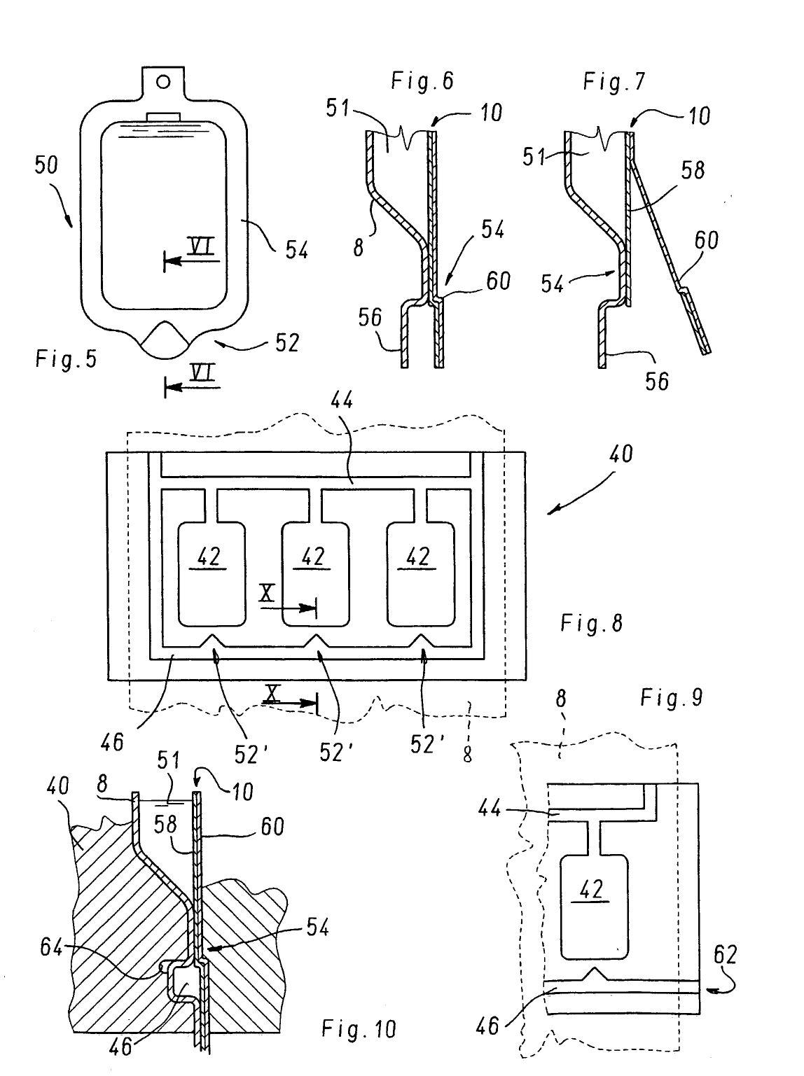

FIG. 5 is a front view of a peelable container;

FIG. 6 is highly enlarged and broken section along the plane VI-VI of FIG. 5;

FIG. 7 is a section as FIG. 6, but relative to a partially open container, i.e. an activated container;

FIG. 8 is a front view of a mould part for peelable containers;

FIG. 9 is a view as FIG. 8, but relative to a variant of the injection means of the forming fluid;

FIG. 10 is a highly enlarged and broken section taken along the plane X-X of FIG. 8 relative to a complete mould.

As shown in FIGS. 1, 2 and 3, a machine for forming containers comprises in sequence: a heating station 2 wherein a first web 8 of thermoformable sheet material and a second web 10 of sheet material (not necessarily thermoformable) are heated, a welding-and-forming station 4, in which the first web 8 and the second web 10 are welded along intended outlines 12 of precursor containers, or pouches, 12a and a forming fluid is injected through injectors 14 in order to form containers defined by the contours 12 and a stabilizing station 6 wherein the shape of the formed containers 16 is stabilized. Downstream of the stabilizing station 6, advancing means 18 is provided in order to advance by steps the first sheet 8 and the second sheet 10 from the stations 2, 4 and 6 toward a cutting station 20 wherein groups 22 of formed containers 16 are separated from the sheets 8, 10 by cutting means 21.

The heating station 2 includes a heating unit 24, such as a heating lamp unit, facing the first web 8 and a screen 25 disposed between the first web 8 and the second web 10. In this way, the first web 8 is more heated than the second web 10 and, if the first web is constituted by plastic material, it will attain a temperature very close to the softening temperature (nearly about some hundred centigrade degrees). Instead the second sheet 10 is only slightly heated, for instance nearly about to a temperature of some ten centigrade degrees.

In the sealing-and-forming station 4, a first mould portion 26 is provided having hollows 28 suitable to receive corresponding regions of the first sheet 8 when forming fluid is injected through the injectors 14, the injectors 14 extending internally into the screen 25 so as to project from it toward the sealing and forming station 4 and laterally so as be connected with ducts of pressurized air, not shown.

In a version not shown, the injectors can also be inserted laterally between the first mould portion 26 and a second mould portion 30 cooperating with the first mould portion 26 in the position shown by arrow F1.

The first mould portion 26 is cooled, so that, when the material of the first web 8, which is deformed by the action of the forming fluid, comes into contact with the cold walls of the first portion 26 of mould, it cools, assuming thereby final shape and dimensions.

The second mould portion 30 is substantially plane, i.e. without the hollow opposed to the first portion 26 of mould, so that, when the first mould portion 26 and the second mould portion 28 are moved in a closing position, they lock between them corresponding portions of the first web 8 and of the second web 10.

The second mould portion 30 is heated, so that the second sheet 10, which lies at a relatively low temperature, is heated up to a temperature suitable to allow to seal it to the first web 8 along the intended outlines 12.

The stabilizing station 6 includes a further first mould portion 32 and a further second mould portion 34, structurally analogous to the first mould portion 26 and to the second mould portion 30, respectively.

However, one or both of the further first mould portion 32 and the further second mould portion 34 can be cooled.

The further second mould portion 34 is not heated, because this might damage the effectiveness of the weld along the intended contours 12 which is carried out at the welding-and-forming station 4.

The further second mould portion 32 is provided with further hollows 36 slightly greater than the hollows 28 of the first mould portion 28 to stabilize the final shape and dimension of the formed containers.

As seen in FIG. 8, a mould 40 of a version of the welding-and-forming station 4 has depressions 42 for receiving the material of the first web 8 deformed by the forming fluid and shows also grooves 44 interconnecting the depressions 42, forming canalizations for the forming fluid defined by the first web 8 and the second web 10. Furthermore the grooves 44 can extend up to define further grooves 46 suitable to form in the first web 8 marginal regions 52′ of external edge of container distanced apart from corresponding regions of the second web 10.

In this way, it is possible to manufacture a container 50 as shown in the FIG. 5, wherein a marginal region 52 of a peripheral weld 54 of a container 50 containing a liquid 51 shows a first edge zone 56 of the first web 8 formed so as to lie substantially detached from the corresponding second edge zone 58 of the second web 10. In this way, when a peelable container has to be activated, in order to cause a permeable film 58 to transpire, so as it can emanate volatile substances in the surrounding environment, it is sufficient to grip one of the edges 56, 58 at the marginal region 52 and to remove a barrier layer 60 initially associated to the permeable film 58.

Advantageously, also the second edge zone 58 of the second sheet 10 can be fully formed so as to increase distance from the first edge zone 56 of the first sheet 8.

As shown in FIG. 9, the further grooves 46 can be fed with pressurized forming fluid independently, i.e. through inlet 62.

As shown in FIG. 10, in order to make easier forming of the edge 56 of the first sheet 8, it is possible to obtain an additional recess 64 in the further grooves 46 at a region designed to form a portion of the edge 56 closer to the weld 54.

1. Method for forming containers, comprising heating (2) sheet material, joining together first and second webs (8, 10) of said sheet material along intended outlines (12) of containers (16) so as to form pouches (12a) bounded by said intended outlines and conduit means (44) leading out into said pouches, said conduit means (44) being suitable to inject therethrough a forming fluid, forming said containers (16, 50) by expanding said pockets by injecting said forming fluid through said conduit means (44), characterized in that, said heating comprises selectively heating said first web (8) more than the second web (10).

2. A method according to claim 1, wherein said expanding comprises expanding outer regions of said sheet material externally of said intended outlines (12) so as to form in each container an opening region (52) in which said first and second webs (8, 10) are spaced apart to each other.

3. A method according to claim 2, wherein said joining further comprises forming further conduit means (46) leading out into said outer regions.

4. Method according to claim 1, or 2, or 3, wherein said selectively heating comprises interposing screen means (25) between said first web (8) and said second web (10).

5. Method according to any preceding claim, wherein said heating comprises heating said second web (10) after selectively heating said first web (8).

6. Method according to claim 5, wherein said heating said second web (10) takes place together with said joining.

7. Method according to any of the preceding claims, wherein said expanding takes place while said first web (8) is cooled.

8. Method according to arty of the preceding claims and further comprising, after said expanding, stabilizing said containers (16).

9. Method for forming containers, comprising heating (2) sheet material, joining a first web (8) and a second web (10) of said sheet material along intended outlines (12) of containers (16, 50) so as to form pouches (12a) bounded by said intended outlines and conduit means (44) leading out into said pouches (12a), said conduit means being suitable to inject therethrough a forming fluid, forming said containers (16) by expanding said pouches (12a) by injecting said forming fluid through said conduit means (44), characterized in that, said expanding comprises expanding outer regions of said sheet material externally of said intended outlines (12) so as to form in each container an opening region (52) in which said first web (8) and said second web (10) are spaced apart to each other.

10. A method according to claim 9, wherein said joining further comprises forming further conduit means (46) leading out into said outer regions.

11. Method according to claim 8, or 9, wherein said heating comprises selectively heating said first web (8) more than said second web (10).

12. Method according to claim 11, wherein said selectively heating comprises interposing screen means (25) between said first web (8) and said second web (10).

13. Method according to any one of claims 9 or 10, wherein said heating comprises heating said second web (10) after heating said first web (8).

14. Method according to claim 13, wherein said heating said second web (10) takes place together with said joining.

15. Method according to any one of claims 9 to 14, wherein said expanding takes place while said first web (8) is cooled.

16. Method according to any one of claims 9 to 15, and further comprising, after said expanding, stabilizing said containers (16).

17. Apparatus for forming containers, comprising indexing a first web (8) and a second web (10) of sheet material through a heating station (2) and through a welding-and-forming station (4) in which opposing portions of said first web (8) and second web (10) are joined together by welding-and-forming means (26, 30) along intended outlines (12) of containers so as to form pouches (12a) and conduit means (44) leading out into said pouches (12a) to inject therein a forming fluid and form said containers (16) by expanding said pouches (12a), characterized in that said heating station (2) comprises selective heating means (24, 25) arranged to selectively heat said first web (8) more than said second web (10).

18. Apparatus according to claim 17, wherein said welding-and-forming means (26, 30) is provided with recess means for receiving regions of said sheet material externally of said intended outlines (12), in said regions said first web (8) being distanced apart from said second web (10) so as to define opening means (52) of said container (50).

19. Apparatus according to claim 18, wherein said welding-and-forming means (26, 30) defines further conduit means (46) in said sheet material, said further conduit means (46) leading out into said regions so as to form said regions when said forming fluid is injected.

20. Apparatus according to any one of claims 17 to 19, wherein said selective heating means comprises screen means (25) interposed between said first web (8) and said second web (10).

21. Apparatus according to any one of claims 17 to 20, and further comprising further heating means (30) in said welding-and-heating means (26, 30) at said welding-and-forming station (4), said further heating means (30) being arranged such as to heat said second web (10).

22. Apparatus according to any one of claims 17 to 21, wherein said welding-and-forming means (26, 30) are provided with cooling means (26) for cooling said first web (8) at said welding-and-forming station (4).

23. Apparatus according to any one of claims 17 to 22, and further comprising, downstream of said welding-and-forming station, a shape stabilizing station (6).

24. Apparatus for forming containers, comprising indexing a first web (8) and a second web (10) of sheet material through a heating station (2) and through a welding-and-forming station (4) in which opposing portions of said first web (8) and second web (10) are joined together by welding-and-forming means (26, 30) along intended outlines (12) of containers so as to form pouches (12a) and conduit means (44) leading out into said pouches (12a) to inject therein a forming fluid and form said containers (16) by expanding said pouches (12a), characterized in that said welding-and-forming means (26, 30) is provided with recess means for receiving regions of said sheet material externally of said intended outlines (12), in said regions said first web (8) being distanced apart from said second web (10) so as to define opening means (52) of said container (50).

25. Apparatus according to claim 24, wherein said welding-and-forming means (26, 30) defines further conduit means (46) in said sheet material, said further conduit means (46) leading out into said regions so as to form said regions when said forming fluid is injected.

26. Apparatus according to claim 24, or 25, wherein said heating station (2) comprises selective heating means (24, 25) arranged to selectively heat said first web (8) more than said second web (10).

27. Apparatus according to claim 26, wherein said selective heating means comprises screen means (25) interposed between said first web (8) and said second web (10).

28. Apparatus according to any one of claims 24 to 27, and further comprising further heating means (30) in said welding-and-heating means (26, 30) at said welding-and-forming station (4), said further heating means (30) being arranged such as to heat said second web (10).

29. Apparatus according to any one of claims 24 to 28, wherein said welding-and-forming means (26, 30) are provided with cooling means (26) for cooling said first web (8) at said welding-and-forming station (4).

30. Apparatus according to any one of claims 24 to 29, and further comprising, downstream of said welding-and-forming station, a shape stabilizing station (6).

31. A container, including first wall means (8) and second wall means (10) defining an interior cavity in which a product (51) is contained, a peripheral weld (54) at which said first wall means (8) and said second wall means (10) are joined together, said second wall means (10) comprising a peelable sheet (60) peelably detachable from a permeable membrane (58) welded to said first wall means (8) at said peripheral weld (54), characterized in that, said first wall means (8) and said second wall means (10) are distanced apart from each other at an outer region externally of said peripheral weld (54) to define a gripping zone of said second wall means (10).
